(19) United States
(12) Patent Application Publication
(10) Pub. No.: US 2007/0167068 A1
(43) Pub. Date: Jul. 19, 2007

(54) Pet exercise and amusement apparatus

(76) Inventors: Mark Floyd, Garland, TX (US); Maria Floyd, Garland, TX (US)

Correspondence Address: JAMES RAY & ASSOCIATES, 2640 PITCAIRN ROAD, MONROEVILLE, PA, 15146, US

(21) Appl. No.: 11/640,016

(22) Filed: Dec. 15, 2006

Related U.S. Application Data
(60) Provisional application No. 60/752,687, filed on Dec. 21, 2005.

(51) Int. Cl. H01R 12/24

(52) U.S. Cl. 439/497

(57) ABSTRACT

An apparatus for providing at least one of pet exercise and amusement. The apparatus comprises a cable member having a predetermined length and formed of a predetermined material. A pair of attachment means are positioned a predetermined distance apart in either a yard or a preselected indoor area. One of the pair of attachment means is engageable with one end of the cable member and a second one of the pair of attachment means is engageable with a respective second end of the cable member. The pair of attachment means are for securing the cable. There is at least one movable member carried by the cable and at least one stretchable cord attached on a first end to the at least one movable member. At least one of a toy and a bone is attached to a second end of the at least one stretchable cord.

### CROSS REFERENCE TO RELATED APPLICATIONS

This application-is closely related to and claims benefit from U.S. Provisional Application Serial No. 60/752,687 filed Dec. 21, 2005.

### FIELD OF THE INVENTION

The present invention relates, in general, to a pet activity center, and, more particularly, the present invention relates to a bone or toys attached to a tethered rope which the dog can play with and chew and at the same time get the necessary exercise to keep the dog fit.

### BACKGROUND OF THE INVENTION

Dogs have an innate desire to chew on and bite virtually any material they can put in their mouths. Gnawing and chewing on, and even eating lawn furniture and chair cushions, lawn ornaments and children's toys and play equipment is a common trait that dog owners note of their beloved pet. Enjoying the outdoors and getting the necessary exercise and stimulation needed to maintain health requires a fun and entertaining toy so that the dog can be entertained while exercising.

Thus, it would be advantageous if there were a means for eliminating the boredom and inactivity of dogs by offering a more exciting way to play in the back yard or even indoors.

### SUMMARY OF THE INVENTION

In a first aspect the present invention provides an apparatus for providing at least one of pet exercise and amusement. The apparatus comprises a cable member having a predetermined length and formed of a predetermined material. A pair of attachment means are positioned a predetermined distance apart in one of a yard and a preselected indoor area, one of the pair of attachment means engageable with one end of the cable member and a second one of the pair of attachment means engageable with a respective second end of the cable member. The pair of attachment means are for securing the cable. There is at least one movable member carried by the cable and at least one stretchable cord attached on a first end to the at least one movable member. At least one of a toy and a bone is attached to a second end of the at least one stretchable cord.

### OBJECTS OF THE INVENTION

It is, therefore, one of the primary objects of the present invention is to provide an apparatus that is used for providing at least one of pet exercise and amusement.

Another object of the present invention is to provide an apparatus that can be installed indoors or outdoors.

Still another object of the present invention is to provide an apparatus that includes spaced apart posts disposed firmly in the yard for holding a cable.

Yet another object of the present invention is to provide an apparatus in which a bone or pet's toys are attached to a stretchable cord.

Another object of the present invention is to provide an apparatus in which the stretchable cords are movably secured to a cable.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the apparatus for pet exercise and amusement when set up for outdoor use.

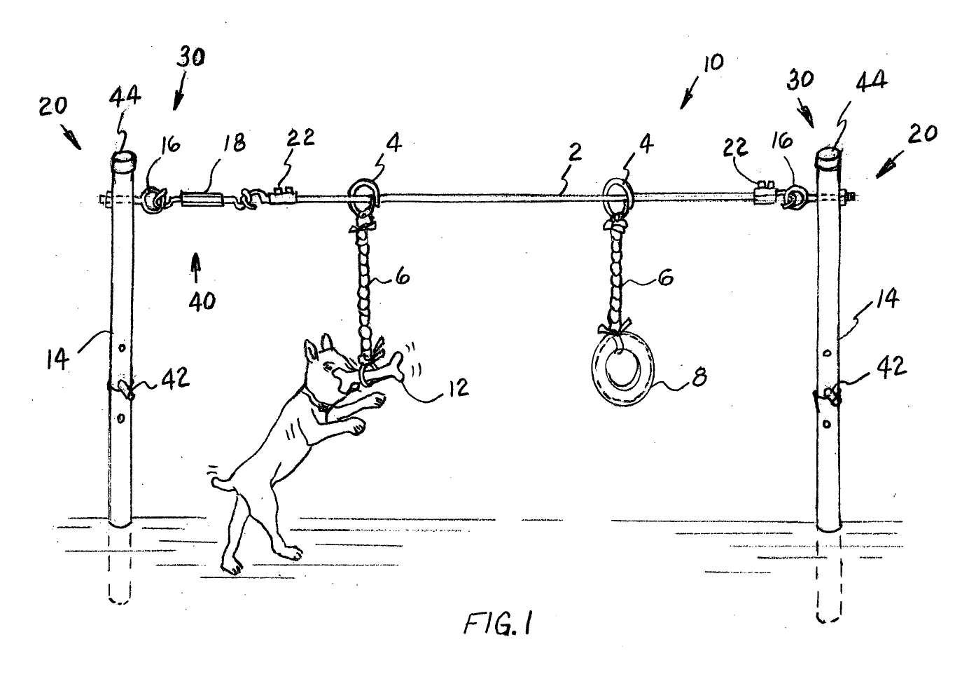

FIG. 2 is a perspective view of the apparatus for pet exercise and amusement when set up for indoor use.

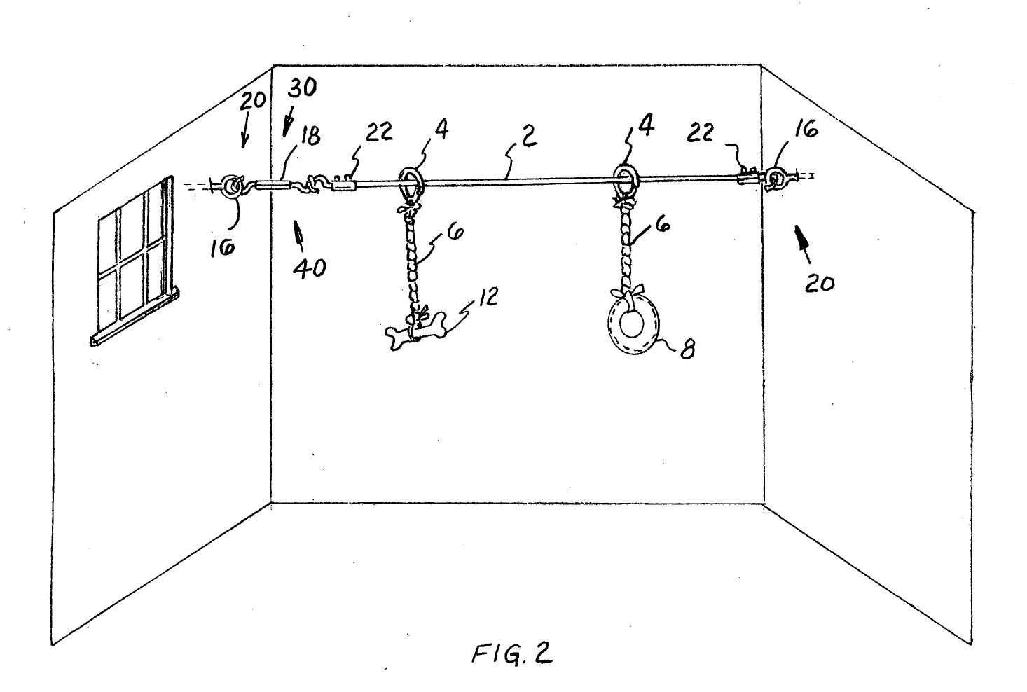

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for providing at least one of pet exercise and amusement. The apparatus 10 comprises a cable member 2 having a predetermined length and formed of a predetermined material. A pair of attachment means, generally designated 20, are positioned a predetermined distance apart in one of a yard and a preselected indoor area, one of the pair of attachment means 20 is engageable with one end of the cable member 2 and a second one of the pair of attachment means 20 is engageable with a respective second end of the cable member 2. The pair of attachment means 20 are for securing the cable member 2. There is at least one movable member 4 carried by the cable 2 and at least one stretchable cord 6 attached on a first end to the at least one movable member 4. At least one of a toy 8 and a bone 12 is attached to a second end of the at least one stretchable cord 6.

The apparatus 10 wherein the pair of attachment means 20 includes a pair of adjustable posts 14. The pair of adjustable posts 14 are firmly anchored in the yard. It is presently preferred that such posts 14 are made of metal and even more preferred that such metal is steel. The posts 14 are positioned spaced apart probably on either side of the yard (unless the yard is very large). The posts should be cemented in the ground approximately two feet deep to give the posts 14 stability an to keep them from moving when the pet (dog) begins to pull on the items disposed thereon.

The posts are adjustable in height by featuring three holes on each post 14 approximately one foot apart. This adjustability is used to provide for growth of the pet. The lowest position is for the dog as a pup or young dog. The second position is when the dog has grown some and the third position is for a fully grown dog. In this manner the apparatus 10 is always challenging the dog. A pin 42 which is inserted through the holes is used to secure the post when the height adjustment is made. Further, it is presently preferred that such posts 124 have a cap member 44 disposed on the top of the post so as to keep water from getting into the post 14.

The apparatus 10 further includes a means, generally designated 30, for securing the cable member 2 to the pair of adjustable posts 14. The securing means includes an eye hook 16 that is attached to each of the pair of posts 14 by means of nuts and bolts.

The apparatus also includes a means, generally designated 40, for tightening the cable when the cable is secured to the posts 14. Such means 40 for tightening the cable 2 is a turnbuckle 18 that is disposed between one end of the cable member 2 and the eye hook 16 for tightening the cable member 2 when it is stretched.

The at least one movable member 4 is a hook 4 which is movably attached on one end with the cable member 2 and having a first end of the stretchable cable 6 attached to a second end of the hook 4. It is presently preferred that such hook 4 is a climber's hook 4. This provides ease of connecting and also provides a very secure attachment to the cable.

If the apparatus 10 is to be placed in an indoor area it is preferred that such indoor area is a basement or a garage. Both of these areas would provide the space necessary for the dog to get exercise as well as amusement. In this case the attachment means 20 is secured to opposite walls of the basement or garage.

The securing means 30 includes clamps 22 for securing the cable to the pair of attachment means 20. The clamps 22 are used whether the apparatus is positioned indoors or outdoors.

It is also presently preferred that the cable member 2 is a wire and it is further preferred that such wire is plastic coated.

Thus the present invention provides an apparatus 10 which can provide a dog with the opportunity to exercise as well as being amused. Dogs love to chew and the toys or bones that are attached to the stretchable cords provide the pet with something to chew on. Also since the cords are attached to a movable member the toy or bone can be moved by the pet the full distance of the cord and with the cord being stretchable the dog can pull on it and stretch the cord but when he releases it the toy rises up to its previous height and the dog may have to jump or stretch to grab it again.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. An apparatus for providing at least one of pet exercise and amusement, said apparatus comprising:
(a) a cable member having a predetermined length and formed of a predetermined material;
(b) a pair of attachment means positioned a predetermined distance apart in one of a yard and a preselected indoor area, one of said pair of attachment means engageable with one end of said cable member and a second one of said pair of attachment means engageable with a respective second end of said cable member, said pair of attachment means for securing said cable;
(c) at least one movable member carried by said cable;
(d) at least one stretchable cord attached on a first end to said at least one movable member; and
(f) at least one of a toy and a bone is attached to a second end of said at least one stretchable cord.

2. The apparatus, according to claim 1, wherein said pair of attachment means includes a pair of adjustable posts, said pair of adjustable posts firmly anchored in such yard.

3. The apparatus, according to claim 2, wherein said adjustable posts further includes a plurality of apertures in said adjustable posts for providing means of a height adjustment of said adjustable posts to a desired height.

4. The apparatus, according to claim 2, wherein said apparatus includes a means for securing said cable member to said pair of adjustable posts.

5. The apparatus, according to claim 4, wherein said means for securing said cable to said post includes an eye hook attached to each of said pair of posts by means of nut and bolt.

6. The apparatus, according to claim 5, wherein said apparatus further includes a means for tightening said cable when said cable is secured to said attachment means.

7. The apparatus, according to claim 6, wherein said means for tightening said cable is a turnbuckle disposed between one end 15 of said cable and said eye hook for tightening said cable when stretched.

8. The apparatus, according to claim 1, wherein said at least one movable member is a hook which is movably attached on one end with said cable and having a first end of said stretchable cable attached to a second end of said hook.

9. The apparatus, according to claim 8, wherein said hook is a climber's hook.

10. The apparatus, according to claim 1, wherein said preselected indoor area is one of a basement and a garage.

11. The apparatus, according to claim 10, wherein said pair of attachment means are secured to walls of said one of said basement and said garage.

12. The apparatus, according to claim 1, wherein said pair of attachment means further includes clamps for securing said cable to said pair of attachment means.

13. The apparatus, according to claim 1, wherein said predetermined material of said cable member is wire.

14. The apparatus, according to claim 11, wherein said wire is a plastic coated wire.

15. The apparatus, according to claim 2, wherein said adjustable posts are made of steel.

16. The apparatus, according to claim 2, wherein said adjustable posts have a cap member disposed on a top of each post.
